(19) United States
(12) Patent Application Publication
(10) Pub. No.: US 2008/0270233 A1
(43) Pub. Date: Oct. 30, 2008

(54) Tracking offline user activity and computing rate information for offline publishers

(75) Inventors: Tony Yip, Redmond, WA (US); Junbo Zhang, Shanghai (CN); Lois Wang, Shanghai (CN); Jacky Wang, Shanghai (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/796,843

(22) Filed: Apr. 30, 2007

(51) Int. Cl. G06Q 30/00

(52) U.S. Cl. 705/14

(57) ABSTRACT

Architecture that leverages enabling technologies for tracking offline activity of a user, and rating performance of offline/online publishers of content and/or advertisements. Knowledge about user offline interests can be accumulated and used to target the user with smart advertisements when offline or online. Moreover, the performance of publishers of the offline content computed by merchants who contract with publishers to provide the best exposure. In support thereof, rate information in the form of response rate and conversion rate can be computed and analyzed for each offline publisher. A publisher referral ID for a publisher is inserted into detectable indicia associated with offline media such as print media, audio media, video media, etc. When a user interacts with the offline content using a cell phone, the captured information is forwarded to an online advertisement component framework for responding to the user interaction (e.g., a purchase transaction or request for further information).

### BACKGROUND

The Internet provides unprecedented opportunity for advertising to a large pool of potential customers ranging from businesses to individuals. Money expended for online advertising in the United States alone, is in the billions of dollars per year, and continues to increase.

Advances in computing systems as well as cellular technology have placed the capability to access content from virtually anywhere using cellular and/or computing devices. For example, smartphone users can now access IP network services and content thereby providing merchants the capability of reaching cellular customers with advertising as well.

A big strength of online advertising is the ability to track the activity of the user while interacting with published content or when browsing through the web pages. Online buying and searching behavior can be tracked using cookies, for example, thereby providing a means for more effective advertising to potential customers. This tracking data provides merchants with knowledge about potential customers such as information about the websites often visited and the content which the user finds interesting. Using this tracking data, merchants can focus and even customize advertising to the user using advertising content that the user is likely to readily consume (e.g., via purchases). However, online commerce accounts for a small percentage of the total retail business while offline commerce retains the bulk of the business.

For offline printed advertising, it is very difficult if not impossible to effectively monitor an individual's buying behavior and interests. Businesses are left to offering enticements or rewards to encourage individuals to respond to surveys about interests, projected purchases, and so on. Businesses expend large outlays of resources in time, money, and employees to inundate the public with unsolicited phone calls and a flood of mailers that are costly, have a limited return, and can turn potential customers away. Thus, businesses continue to seek more cost effective ways in which to track offline user activity and buying behavior and to determine more effective means for reaching potential customers.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture leverages enabling technologies (e.g., encoding schemes and capture devices) that help in tracking the offline activity of a user. Knowledge of user interests can be accumulated and used to target the user with smart advertisements about interests being searched when offline or online.

Additionally, publishers of offline content can also be tracked and rated for performance by merchants who contract with publishers to provide the best exposure. In support thereof, rate information in the form of response rate and conversion rate can be computed and analyzed for each offline publisher. A unique referral ID is created for each publisher for insertion or encoding as detectable indicia into offline media (or content) such as print media, audio media, video media, etc. When a user interacts with the offline content and/or advertisements using a capture device such as cell phone, the captured information is forwarded to an online gateway and advertisement framework for responding to the user interaction (e.g., a purchase transaction or request for further information).

The tracking information can be sent to the gateway and advertisement framework for further processing and storing of knowledge about the user's offline behavior patterns and a publisher's performance. This provides for a centralized and accessible location for merchants and publishers to conduct advertising and content processing.

The indicia can be included as part of a QR code, a bar code, RFID (radio frequency identification), and A/V (audio/video) background noise encoding, for example, where users can respond with a capture device such as cell phone (e.g., with a camera). The publisher is provided with a plug-in tool that facilitates encrypting a publisher referral ID into the advertisement indicia. When the user responses to an ad by capturing and sending the QR image, for example, to a service number designated for this specific service, publisher response rate is computed. When the user places an order by sending a response with the encoded publisher referral ID, the conversion rate of the publisher accrues. The higher the response rate and/or the conversion rate, the more effective the publisher, and the more the publisher can charge the merchant.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system for tracking user interaction with offline content.

FIG. 2 illustrates a diagram of a system of a centralized mobile platform for processing and accounting of offline user activity related to published offline content.

FIG. 3 illustrates a system that employs an accounting component for computing and accruing response and/or conversion rate information.

FIG. 4 illustrates a more detailed exemplary system for offline tracking and accounting purposes.

FIG. 5 illustrates exemplary applications that can receive and provide user information related to offline tracking activity of a user.

FIG. 6 illustrates an ad component ecosystem for merchant-publisher ad processing.

FIG. 7 illustrates a method of processing offline user activity.

FIG. 8 illustrates a method of providing a relationship between offline user activity and a user.

FIG. 9 illustrates a method of tracking offline user activity via a cell phone.

FIG. 10 illustrates a method of computing a response rate for offline publishers.

FIG. 11 illustrates a method of employing A/V noise encoding to detect offline user activity.

FIG. 12 illustrates a screenshot of a printed media page presented to a publisher for indicia insertion when using a publisher plug-in tool.

FIG. 13 illustrates a screenshot of the printed media page presented to a publisher after insertion of ad content and indicia technology into the footprint area when using the publisher plug-in tool.

FIG. 14 illustrates a depiction of printed media having a QR code as indicia printed as part of the paper.

FIG. 15 illustrates decoded information presented on the cell phone after capture and local processing.

FIG. 16 illustrates a block diagram of a computing system operable to facilitate offline tracking and rate information processing in accordance with the disclosed architecture.

FIG. 17 illustrates a schematic block diagram of an exemplary computing environment that facilitates offline tracking and rate information processing in accordance with the disclosed architecture.

### DETAILED DESCRIPTION

The disclosed architecture leverages enabling technologies (e.g., encoding schemes) that help in tracking the offline activity of a user. Knowledge of user favorites and interests can be accumulated and used to target the user with smart advertisements (“ads”) about interests being searched when offline or online. Moreover, publishers and merchants who hire the publishers are provided a centralized system for efficiently and effectively selecting published merchant content, and for rating performance based on information obtained for the offline user activity.

One ubiquitous device that most users carry is the cell phone. The disclosed architecture leverages the mobile platform to track the user's offline purchase behavior and/or user exposure to ads when in the offline mode. Different enabling technologies are employed to encourage users to respond to ads and content with the cell phone. These technologies include but are not limited to QR (quick response) code, A/V (audio/video) noise encoding, bar codes, and RFID (radio frequency identification).

Users are enticed to associate cell phone numbers with a web ID (e.g., an ID used as part of Windows Live™ by Microsoft Corporation). When the user responds to market events with the cell phone, the web ID can be obtained because of the prior established relationship with the user's cell phone number. Keywords can be logged for each response the user makes thereby providing a means for tracking the user's offline interaction with content and ads, and then analyzing the tracked information for other purposes. This knowledge can be used to provide smart or targeted ads to the user in an online mode. For instance, consider that the user has in the past made several dinner reservations at a Chinese restaurant by sending messages (e.g., SMS-short message service, MMS-multimedia messaging service, instant messaging, etc.) related to such interest. Keywords such as “Chinese food” can be extracted and logged in an online user's profile. Thereafter, when the user is interacting with a mapping and location service (e.g., Virtual Earth™ by Microsoft Corporation) to search for a destination, ads about Chinese food can be automatically retrieved and presented within the vicinity of the destination.

Advertisements can be presented that invite (or entice) users to participate in marketing events such as lucky draw, feedback surveys, requiring further information, purchases, and other requirements.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof

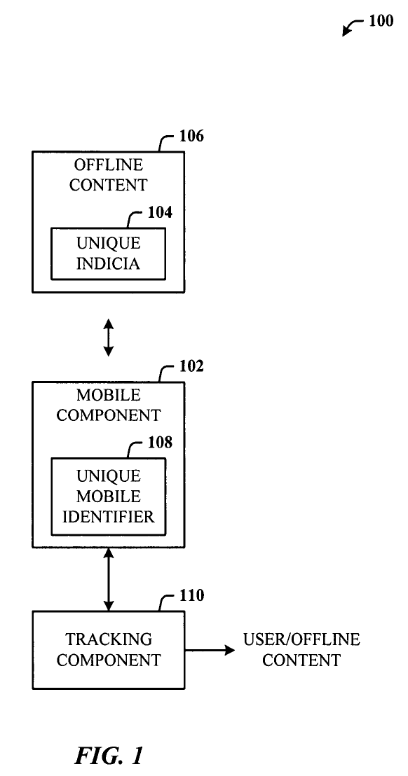

Referring initially to the drawings, FIG. 1 illustrates a computer-implemented system 100 for tracking user interaction with offline content. The system 100 can include a mobile component 102 (e.g., a cell phone) of a user for capturing unique indicia 104 associated with offline content 106 (e.g., printed ads). For example, a cell phone with image and/or video capture capability (e.g., camera) and/or audio capture capability (e.g., a microphone) can be utilized to capture (e.g., record) the indicia on (or associated with) the offline content 106 (e.g., a magazine advertisement). The indicia 104 can be a QR code, audio clip, video clip, or RFID, for example. Other suitable indicia can be employed such as bar codes and multi-dimensional codes that can be captured and processed locally by the mobile component 102 and/or shipped to a remote location for processing to obtain the unique information encoded therein.

The mobile component 102 can also include or be associated with a unique mobile identifier 108 (e.g., the subscriber identity module (SIM), phone number, or other unique information). A datastore can store this association for retrieval when the user is detected to be interacting with offline content, for example. The datastore can also be used to store user personal information and the content associated with the unique indicia, the time the interaction occurred, whether a purchase was made, and so on, to develop historical information about user offline and/or online buying behavior.

The system 100 can also include a tracking component 110 for tracking user interaction with the offline content 106 based in part on association of the unique mobile identifier 108 of the mobile component 102 with the captured indicia 104. In other words, by processing the unique mobile identifier 108, the user (or subscriber) name can be obtained and associated with the unique indicia 104, and thus, the offline content 106. Offline interest and/or buying behavior can then be obtained. The offline information can then be used in different ways, such as pushing targeted advertising to the user when the user is known to be online. The online advertisements can be pushed not only to the mobile component 102 for presentation to the user, but also via other devices which are network-capable, for example, computers, PDAs, tablet PCs, etc.

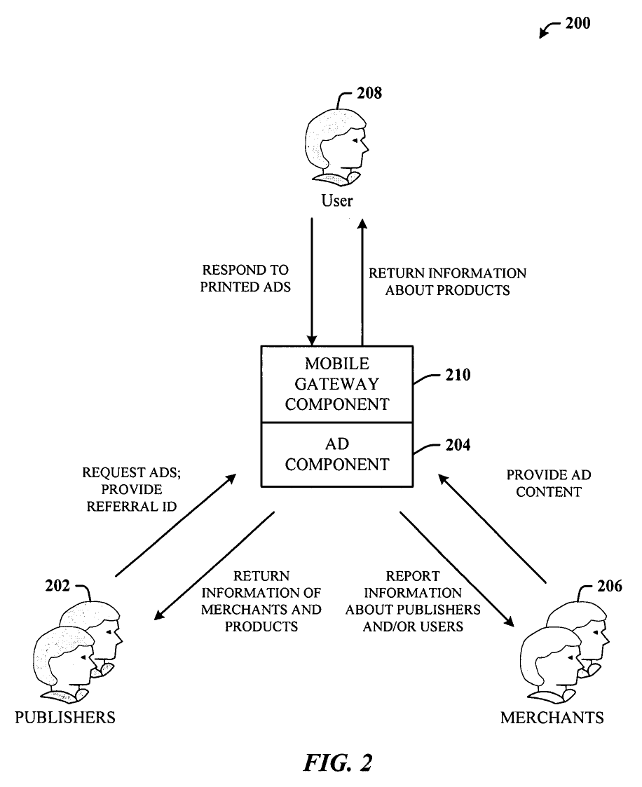

FIG. 2 illustrates a diagram of a system 200 of a centralized mobile platform for processing and accounting of offline user activity related to published content. Initially, a publisher 202 requests an advertisement from an ad component 204 and sends a unique publisher referral ID to the ad component 204. The ad component 204 returns ad content (e.g., related to an article of commerce) to the publisher 202, the content containing the publisher referral ID and ad ID encoded therein in the form of indicia (e.g., bar code, QR code, scannable hyperlink, etc.). For example, the publisher 202 requests the ad content returned with an associated QR code as part of the content image. In other words, the content image returned by ad component 204 can include the product information of a merchant 206 and the publisher's referral ID. For example, the publisher 202 can request that a QR image and the readable content associated with the product be printed together into the publisher's magazine.

After the content and indicia are made accessible (e.g., published in print media), a user 208 responds to the offline ad (e.g., in a newspaper, magazine, on a product, associated with a service) by capturing (e.g., scanning, recognition processing), using a cell phone, indicia associated with the advertisement. In other words, if the user 208 finds the ad interesting, the user can capture the image using the cell phone and purchase the product by sending the image to a related service number. Note that although this description is specific to a cell phone, other mobile capable capture devices or systems can be employed. The captured information is then transmitted to a mobile gateway component 210 where the mobile gateway component 210 decodes the image server-side and obtains the information about the merchant product (or service) and the publisher referral ID. The ad component 204 can provide additional information about of the product (and/or service) to the user in a return message.

At this point, the response (or “hit”) rate of the publisher accrues, since the user 208 did interact sufficiently to trigger system processes. The user 208 can confirm the purchase by replying to the message. Then, the publisher's conversion rate accrues. The higher the response/conversion rate, the more the publisher 202 can charge the merchant 206.

The merchant 206 is informed by the ad component 204 to process the transaction as soon as the user 208 confirms the purchase. On a regular basis (e.g., daily, weekly, etc.), the merchant 206 can request and/or receive a report from the ad component 204 that includes or summarizes response/conversion rate data of different publishers 202 that have published content associated with the merchant 206. The response/conversion rate data can be used to adjust the selection of publishers 202 by the merchant and or the ad component 204.

In addition to tracking publisher performance, the offline activity of the user 208 can also be tracked by inviting or enticing the user to associate user information (e.g., a cell phone number) with a web ID. The mobile gateway component 210 can then obtain the user's online identity when the user 208 responds with a cell phone, for example. Thus, knowledge about the offline user activity (e.g., favorites, purchase behavior patterns, etc.) that is accumulated can be used to enhance online activities, such as activities associated with other products related to messaging, searching, points accumulation, mapping and location services, email, and so on.

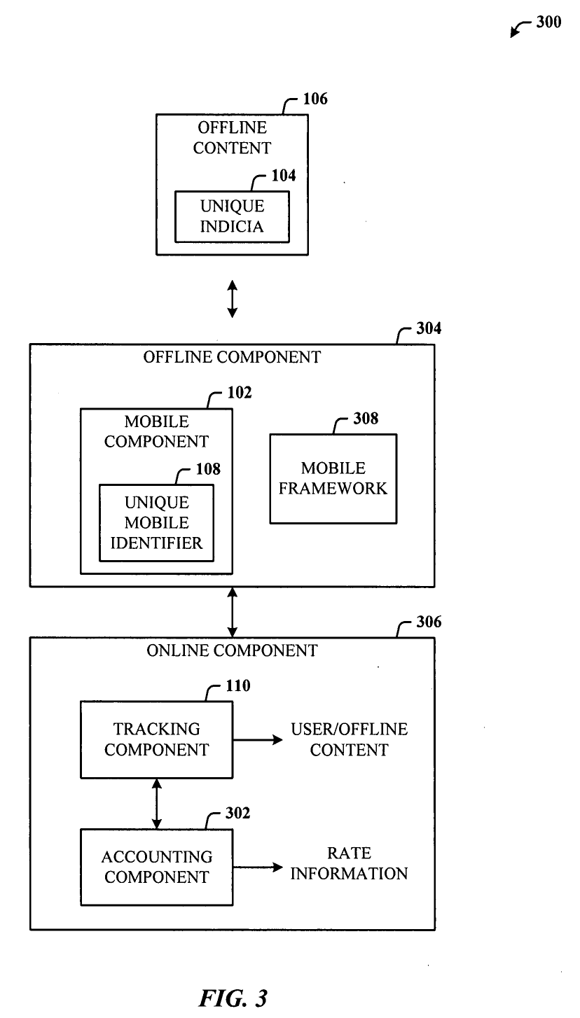

FIG. 3 illustrates a system 300 that employs an accounting component 302 for computing and accruing response and/or conversion rate information. The system 300 includes an offline component 304 for handling offline activity, and an online component 306 for processing online activities. The offline component 304 can include a mobile framework 308 (e.g., mobile operators) that facilitates interaction by a mobile user with the offline content 106 and the associated indicia 104. Thus, a cell phone user accessing the content 106 and indicia 104 can communicate the indicia 104 and the mobile identifier (e.g., cell phone number) to the online component 306 via the offline component 304 for further processing.

The online component 306 can include the ad component 204 and the mobile gateway component 210 of FIG. 2. The tracking component 110 has been previously described and can include other capabilities described herein. The online component 306 also includes the accounting component 302 for processing publisher and merchant information such as reconciling publisher data obtained from the content 106, applying points or rewards to the user, and rate information to merchants, for example. The tracking and account components (110 and 302) provide a portion of the overall functionality of the online component 306.

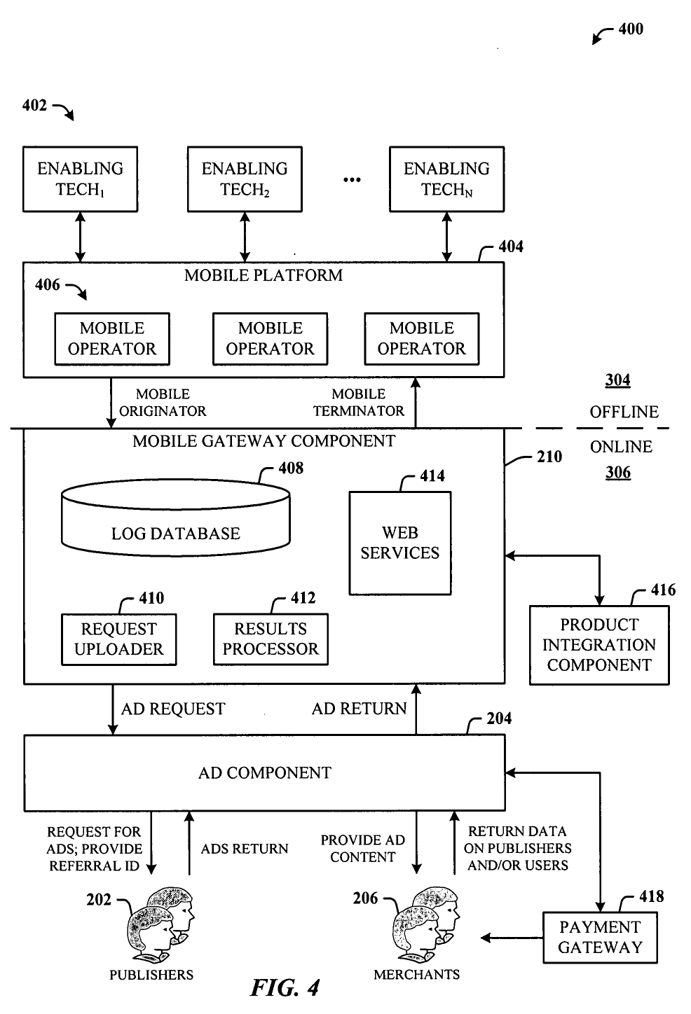

FIG. 4 illustrates a more detailed exemplary system 400 for offline tracking and accounting purposes. The offline portion includes a plurality of enabling technologies 402 (denoted ENABLING TECH₁, ENABLING TECH₂, . . . , ENABLING TECH_{N}, where N is a positive integer) for accessing, capturing, and transmitting content-related information. The enabling technology 402 can include a camera, bar code scanner, QR code scanner or capture capability (e.g., the camera or imager), microphone for receiving audio data (e.g., speech, music), video data (e.g., via video camera) and RFID reader for reading RFID tags or other radio frequency type tags or information.

The enabling technology 402 inputs the content and/or indicia information to a mobile platform 404 as part of the offline framework 304, which mobile platform 404 can include multiple different mobile operators 406 for communicating the offline information to the online framework 306. More specifically, the mobile platform 404 can be considered a message originator to the mobile gateway component 210.

The gateway component 210 can include a logging database 408 for storing information such as content selected, service number, extracted publisher referral ID data, and so on. The gateway component 210 also includes a request uploader 410 for processing and uploading ad requests to the ad component 204. A results processor 412 processes information for internal functionality of the gateway component 210, and a web services component 414 facilitates web access for online applications, for example. Ad requests are processed through the ad component 204, returning the ad content to the gateway component 210.

The ad component 204 facilitates publisher requests for ad content and ad returns. Additionally, the merchants 206 can interface to the ad component 204 to provide ad content and to receive publisher and/or user data.

A product integration component 416 is provided for passing user activity information to other applications which the user may access. For example, based on content, offline purchases, and/or user profile information, a geolocation application can receive some of this information to react dynamically to user interaction with the geolocation information to present or anticipate geolocation information the user may be interested in needing at any point in time.

The system 400 can also include a payment gateway 418 for facilitating payments to the merchants 206 based on user purchase activity. The gateway 418 can interface to conventional payment mechanisms including, but not limited to, online transfer and bill paying technologies, ACH (automated clearinghouse), wire transfers, and so on.

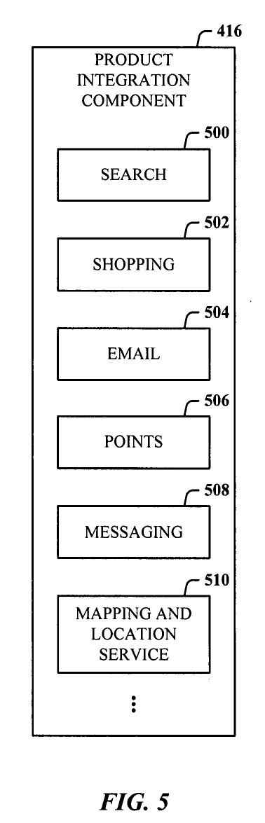

FIG. 5 illustrates exemplary applications that can receive and provide user information related to offline tracking activity of a user. For example, user offline and/or online activity information and user profile data can be employed in the product integration component 416 by a search application 500 to focus the search to information that the user is more likely to desire. Similarly, a shopping application 502 can receive or request the user information for automatically generating search queries, searching, filtering, ranking and/or focusing searches on topic of interest as obtained from the user information related to the offline activity. An email application 504 can use the user information to auto-search and fill contacts into an email message, filter messages (e.g., spam), and so on, based on the user information.

A points application 506 can be used to monitor user activity related to points-generating content, for example, and processing, accumulating and storing the points for the user. A messaging application 508 (e.g., instant messaging, SMS, MMS, etc.) can request or receive the user information to automate messaging processes. A mapping and location service 510 can use the user information or portions thereof to anticipate the information the user may want to see or hear based on historical offline activity. In other words, if the user accesses content related to Chinese food, it can be inferred that the user is interested in a restaurant in the geographic location of the user. The user location information can be obtained based on the cell phone number, for example, or roaming information related to where the user is currently located.

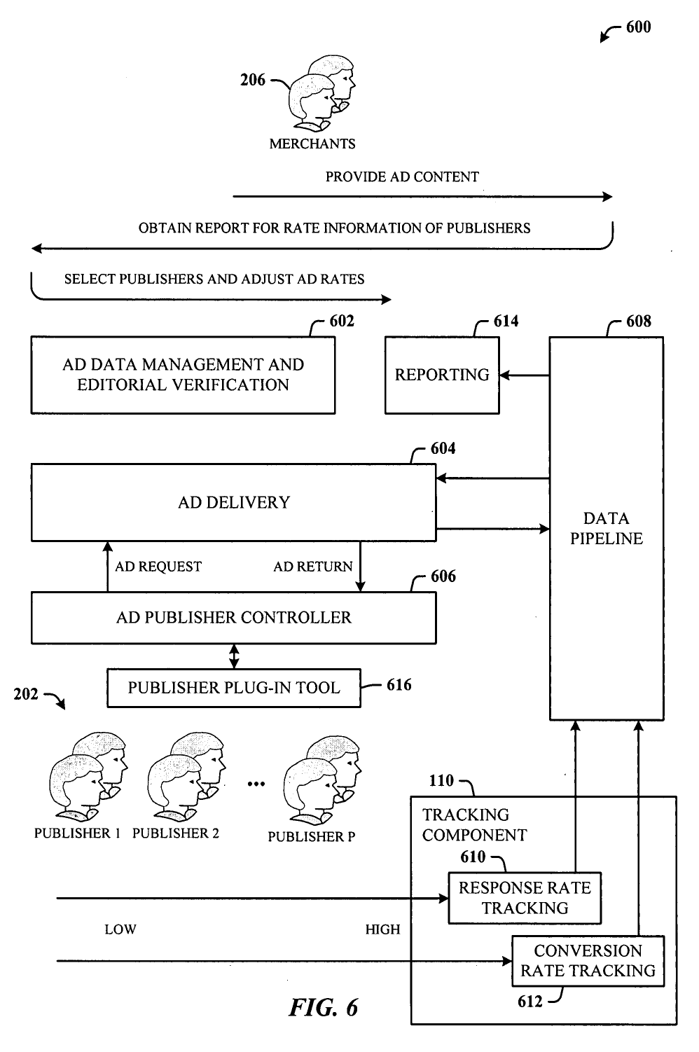

FIG. 6 illustrates an ad component ecosystem 600 for merchant-publisher ad processing. The merchants 206 provide ad content to the ecosystem 600. The ecosystem 600 includes an ad data management and editorial component 602 for storing data and verifying the content is acceptable and suitable for publication. An ad delivery component 604 processes ad content to and from the publishers 202 (denoted PUBLISHER 1, PUBLISHER 2, . . . , PUBLISHER P, where P is a positive integer) via an ad publisher controller 606. The publisher controller 606 provides the interface to publisher systems and applications. The ad delivery component 604 interfaces to a data pipeline component 608 for obtaining ads from the content pool (e.g., the ad component 204 of FIG. 4) where various merchants 206 submit ads. Tracking component 110 tracks a response rate 610 and a conversion rate 612, and sends offline user response tracking data (610 and 612) into the data pipeline 608 for routing the data (610 and 612) to the reporting component 614. The reporting component 614 interfaces to the data pipeline 608 for receiving the data (610 and 612) and outputting reports that can indicate the performance of the publishers, as well as the merchants.

The publishers 202 can be provided with a plug-in tool 616 for publisher programs for interfacing to the ad controller 606. The tool 616 can be provided after subscribing, and which tool has a one-on-one relationship with a unique publisher referral ID. Upon signup, the publisher is requested to fill out a property form which includes, but is not limited to, information such as publisher name, market category (e.g., automobile, fashion), location, and billing information. When the publisher logs in, ad feeds can be searched using keywords, and the plug-in tool 616 sends the ad requests to the ad component ecosystem 600. The ad component ecosystem 600 caches the ad content provided by merchants and returns ads to the plug-in tool 616. The tool 616 also facilitates the screening of a publisher that is not appropriate for delivering certain ads based on the information the publisher provided during signup. For instance, an automobile publisher is not appropriate for delivering a cosmetics ad. The tool 616 encodes the product information together with the publisher referral ID into the QR image (or other indicia such as RFID, A/V noise signals, audio, etc.). The publisher can obtain product information in both readable text and the QR image using the plug-in tool 616 and place the product information into a page to be printed and published.

In other words, multiple offline publishers 202 can pull ads from the ecosystem 600 and embed or associate QR code into the ad content before the ads are inserted into newspapers, magazines, or posters, for example. The QR image includes information about the merchant product, as well as the publisher referral ID. When a user views the ad in printed media owned by Publisher 1 and responds using the cell phone, a message is sent to the ad component ecosystem 600 via the mobile gateway 210 of FIG. 4 where the publisher referral ID is extracted from the QR image and sent to the ecosystem 600.

Generally, the ecosystem 600 tracks the response rate and conversion rate for each publisher based on the publisher referral ID. The higher the response rate/conversion rate, the more the publishers 202 can charge the merchants 206. Merchants 206 are able to request and receive (or generate directly) a report from the ecosystem 600 to analyze the effectiveness of the different publishers 202 being used or of other publishers that could be used. Thereafter, merchants 206 can adjust ad content according to the market response and change publishers based on performance.

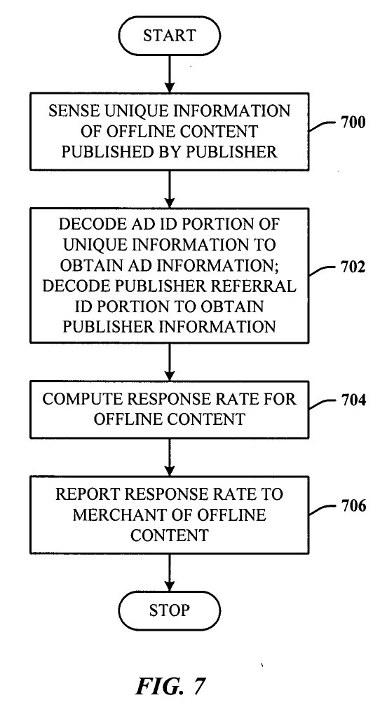

FIG. 7 illustrates a method of processing offline user activity. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

At 700, unique information of offline content published by a publisher is sensed using a user device. At 702, the ad ID portion of the unique information is decoded in order to know which ad the user is perceiving (e.g., viewing). Additionally, the publisher referral ID is decoded in order to know from which publisher the user captured this ad. The publisher referral ID is not displayed to the user on the user handset but is sent back to the receiving server together with the user response. At 704, a response rate for the offline content is computed. At 706, the response rate is reported to a merchant associated with the offline content.

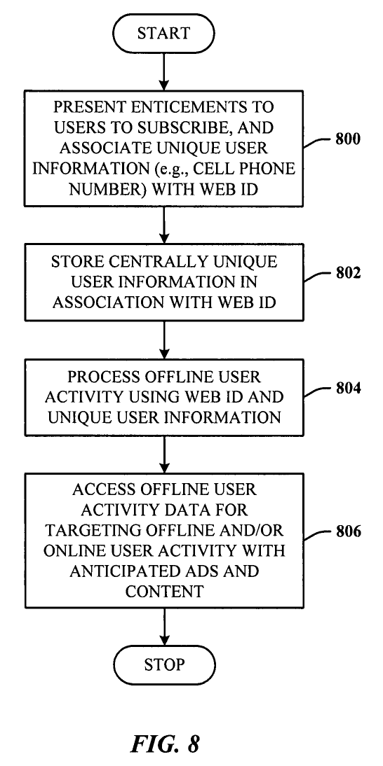

FIG. 8 illustrates a method of providing a relationship between offline user activity and a user. At 800, enticements are presented to users to subscribe, and subscription includes associating unique user information with a web ID. At 802, the associated unique user information and web ID are stored centrally for access offline and online. At 804, offline user activity is then processed using the relationship of the user information and web ID. At 806, offline user activity data can then be accessed for targeting future offline and/or online user activity with anticipated ads and content.

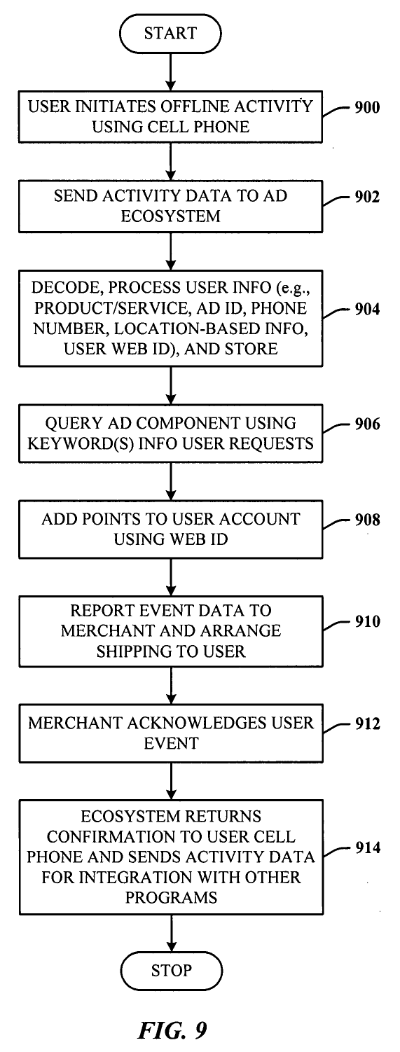

FIG. 9 illustrates a method of tracking offline user activity via a cell phone. At 900, the user initiates offline activity using the cell phone. This can include simply requesting information by capturing indicia on print media and/or transacting a purchase to buy products and/or services presented in the media. At 902, the user activity data is transmitted manually and/or automatically to the ad ecosystem in association with the user information. The user activity data can include the content indicia and product/service number associated with the offline content. At 904, the ecosystem decodes and processes the user activity data to obtain the publisher referral ID, ad ID, content, phone number, and user's web ID, and stores this information for later processing. Location based information can also be determined based on the cellular information obtained from the phone number. At 906, the ad component is queried using one or more keywords extracted from messaging or user activity data. At 908, the user account associated with the web ID is updated by adding points or rewards information. At 910, event data such as a purchase or simply the user requesting further information about the product/service is communicated to the corresponding merchant, and arrange delivery (e.g., shipping if a purchase, or further information if a request for such) to the user. At 912, the merchant acknowledges the user event. At 914, the ecosystem returns confirmation of the request and/or purchase to user cell phone, and sends activity data for integration with other programs.

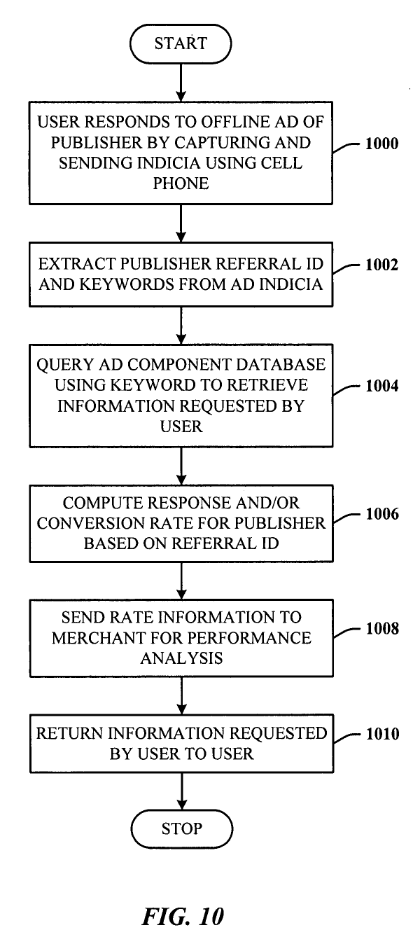

FIG. 10 illustrates a method of computing a response rate for offline publishers. At 1000, the user responds to offline ad of publisher by capturing and sending indicia using cell phone. At 1002, the publisher referral ID and one or more keywords are extracted from the indicia in the response. At 1004, the ad component is queried using the keywords to retrieve the information requested by the user. At 1006, the response and/or conversion rates are then computed for the given publisher based on the referral ID. At 1008, the rate information is sent to the merchant associated with the ad content for performance analysis of the publisher. At 1010, the information requested by the user is returned to the user.

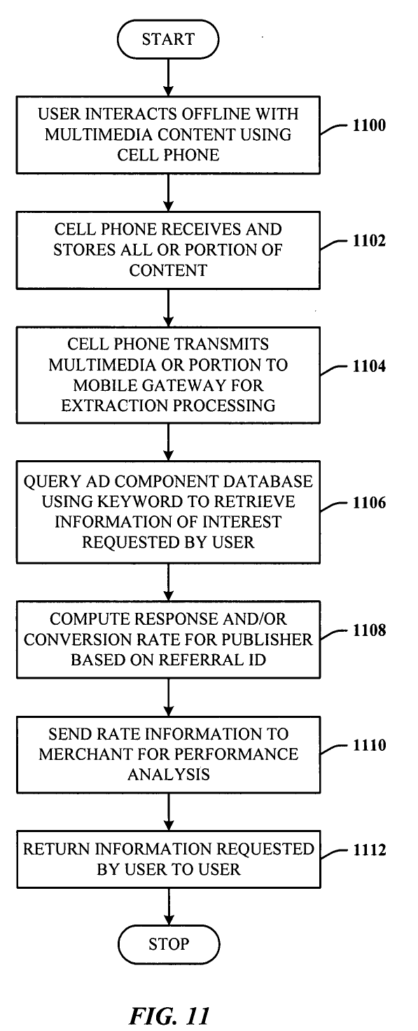

FIG. 11 illustrates a method of employing A/V noise encoding to detect offline user activity. At 1100, an offline user interacts (e.g., causes to be played) with multimedia content (e.g., audio file, audio/video file, video file, etc.) using a cell phone. The multimedia content has encoded therein indicia that includes a publisher referral ID and information about the media file content (e.g., musical group, titles, record label, vendor product) being presented in playing the file. In one example, the user views and listens to a TV program that plays a background chirp or series of tones encoded and buried as background noise to the program that are recorded by the cell phone. At 1102, the cell phone receives and stores the multimedia content. At 1104, the cell phone transmits the multimedia content (and indicia) to the gateway system for extraction and processing. At 1106, the referral ID and product/service information is extracted, and ad component database queried using keywords to retrieve information of interest requested by user. At 1108, the response and/or conversion rates are then computed for the given publisher based on the referral ID. At 1110, the rate information is sent to the merchant associated with the ad content for performance analysis of the publisher. At 1112, the information requested by the user is returned to the user.

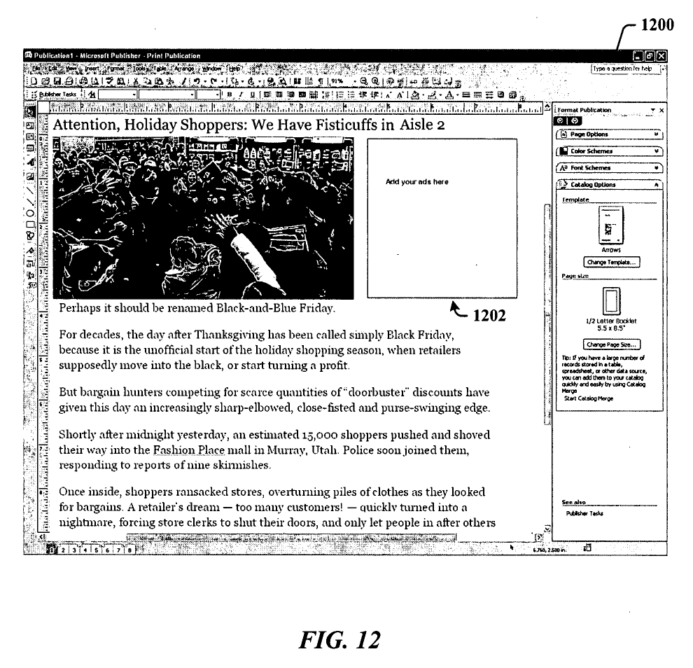

FIG. 12 illustrates a screenshot of a printed media page 1200 presented to a publisher for indicia insertion when using a publisher plug-in tool. The printed page 1200 includes a footprint area 1202 into which the publisher can insert merchant ads.

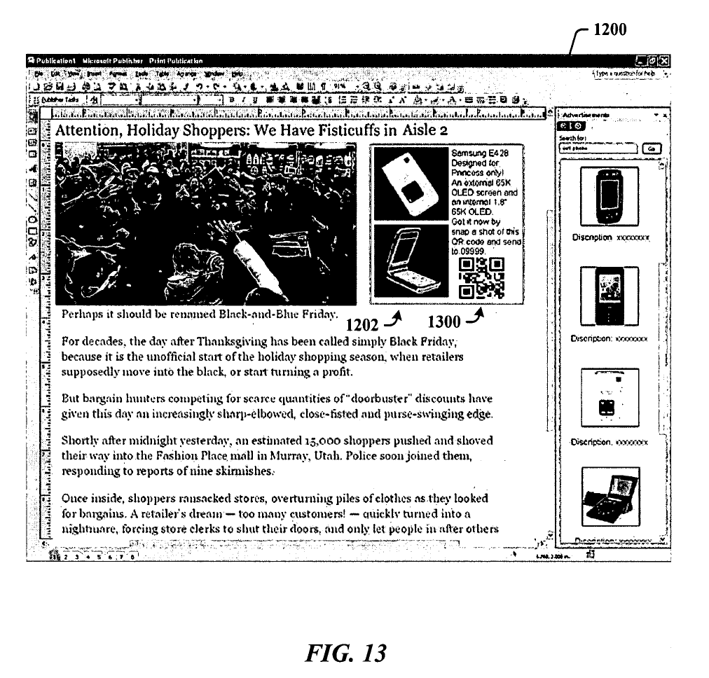

FIG. 13 illustrates a screenshot of the printed media page 1200 presented to a publisher after insertion of ad content and indicia technology 1300 into the footprint area 1202 when using the publisher plug-in tool. The enabling technology utilized in this particular instance by the publisher is a QR code. The tool facilitates auto-generation of the QR code with embedded publisher referral ID and ad information.

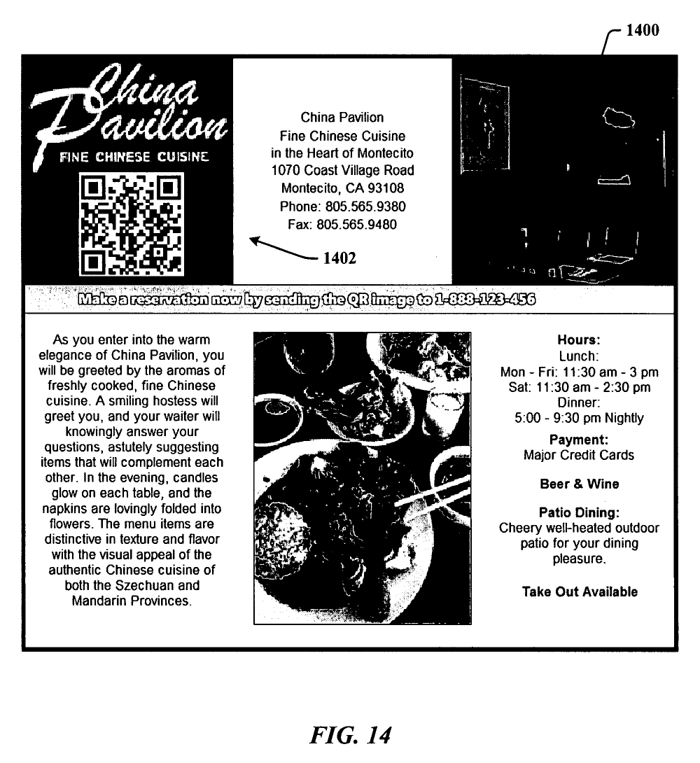

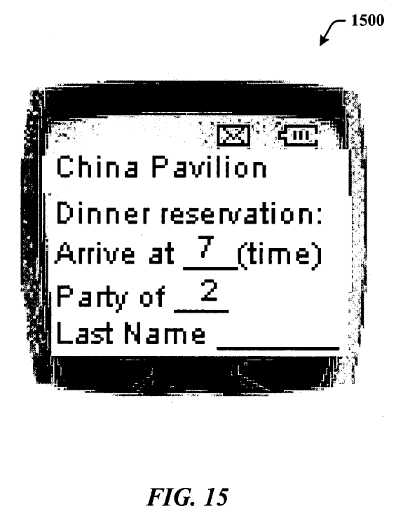

FIG. 14 illustrates a depiction of printed media 1400 having a QR code 1402 as indicia printed as part of the paper. The user can then use a cell phone to capture the QR code 1402 for processing. FIG. 15 illustrates decoded information 1500 presented on the cell phone after capture and local processing. In addition to the readable and editable text the user can send to the service number in response to the printed ad, the message also includes encrypted information not displayed to the user. The encrypted information includes the publisher referral ID and the ad ID.

While certain ways of displaying information to users are shown and described with respect to certain figures as screenshots, those skilled in the relevant art will recognize that various other alternatives can be employed. The terms “screen,” “screenshot”, “webpage,” “document”, and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

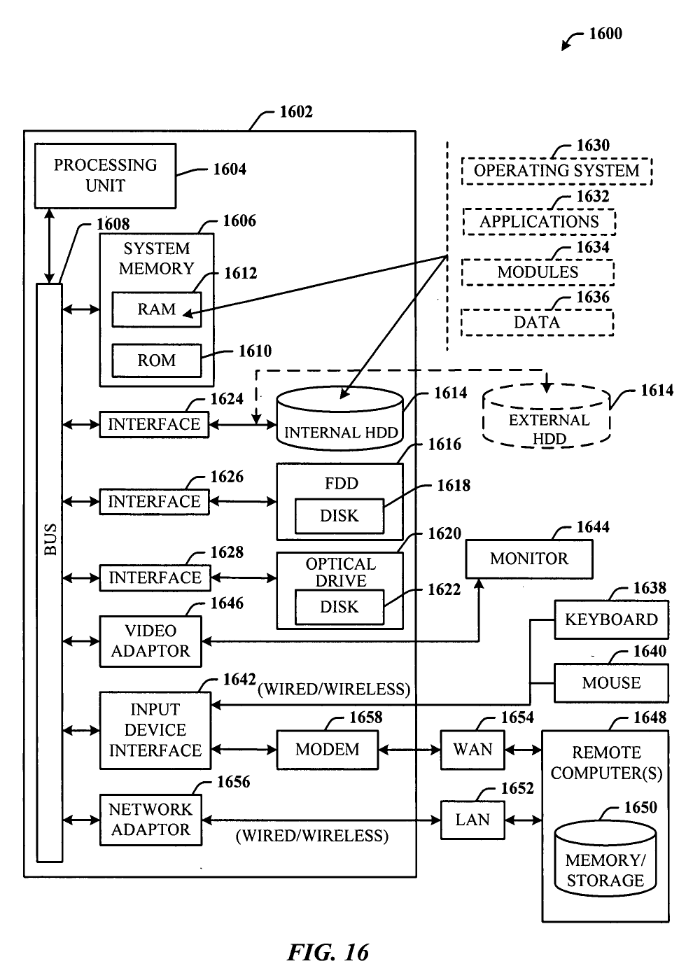

Referring now to FIG. 16, there is illustrated a block diagram of a computing system 1600 operable to facilitate offline tracking and rate information processing in accordance with the disclosed architecture. In order to provide additional context for various aspects thereof, FIG. 16 and the following discussion are intended to provide a brief, general description of a suitable computing system 1600 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 16, the exemplary computing system 1600 for implementing various aspects includes a computer 1602, the computer 1602 including a processing unit 1604, a system memory 1606 and a system bus 1608. The system bus 1608 provides an interface for system components including, but not limited to, the system memory 1606 to the processing unit 1604. The processing unit 1604 can be any of various commercially available processors. Dual microprocessors and other multi-processor architectures may also be employed as the processing unit 1604.

The system bus 1608 can be any of several types of bus structure that may further interconnect to a memory bus (with or without a memory controller), a peripheral bus, and a local bus using any of a variety of commercially available bus architectures. The system memory 1606 includes read-only memory (ROM) 1610 and random access memory (RAM) 1612. A basic input/output system (BIOS) is stored in a non-volatile memory 1610 such as ROM, EPROM, EEPROM, which BIOS contains the basic routines that help to transfer information between elements within the computer 1602, such as during start-up. The RAM 1612 can also include a high-speed RAM such as static RAM for caching data.

The computer 1602 further includes an internal hard disk drive (HDD) 1614 (e.g., EIDE, SATA), which internal hard disk drive 1614 may also be configured for external use in a suitable chassis (not shown), a magnetic floppy disk drive (FDD) 1616, (e.g., to read from or write to a removable diskette 1618) and an optical disk drive 1620, (e.g., reading a CD-ROM disk 1622 or, to read from or write to other high capacity optical media such as the DVD). The hard disk drive 1614, magnetic disk drive 1616 and optical disk drive 1620 can be connected to the system bus 1608 by a hard disk drive interface 1624, a magnetic disk drive interface 1626 and an optical drive interface 1628, respectively. The interface 1624 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and RAM 1612, including an operating system 1630, one or more application programs 1632, other program modules 1634 and program data 1636. The one or more application programs 1632, other program modules 1634 and program data 1636 can include the offline indicia 104, mobile identifier 108 and tracking component 110 of FIG. 1, the ad component 204 and mobile gateway component 210 of FIG. 2, aspects of the mobile framework 308 and accounting component 302 of FIG. 3, the database 408, request uploader 410, result processor 412, web services 414 integration component 416 and payment gateway 418 of FIG. 4, the programs 500, 502, 504, 506, 508 and 510 of FIG. 5 and components ( 602, 604, 606, 608, 610, 612, 614, and 616) of FIG. 6, for example.

All or portions of the operating system, applications, modules, and/or data can also be cached locally in the RAM 1612 or remotely at a server, for example. It is to be appreciated that the disclosed architecture can be implemented with various commercially available operating systems or combinations of operating systems.

A user can enter commands and information into the computer 1602 through one or more wire/wireless input devices, for example, a keyboard 1638 and a pointing device, such as a mouse 1640. Other input devices (not shown) may include a microphone, an IR remote control, a joystick, a game pad, a stylus pen, touch screen, or the like. These and other input devices are often connected to the processing unit 1604 through an input device interface 1642 that is coupled to the system bus 1608, but can be connected by other interfaces, such as a parallel port, an IEEE 1394 serial port, a game port, a USB port, an IR interface, etc.

A monitor 1644 or other type of display device is also connected to the system bus 1608 via an interface, such as a video adapter 1646. In addition to the monitor 1644, a computer typically includes other peripheral output devices (not shown), such as speakers, printers, etc.

The computer 1602 may operate in a networked environment using logical connections via wire and/or wireless communications to one or more remote computers, such as a remote computer(s) 1648. The remote computer(s) 1648 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1650 is illustrated. The logical connections depicted include wire/wireless connectivity to a local area network (LAN) 1652 and/or larger networks, for example, a wide area network (WAN) 1654. Such LAN and WAN networking environments are commonplace in offices and companies, and facilitate enterprise-wide computer networks, such as intranets, all of which may connect to a global communications network, for example, the Internet.

When used in a LAN networking environment, the computer 1602 is connected to the local network 1652 through a wire and/or wireless communication network interface or adapter 1656. The adaptor 1656 may facilitate wire or wireless communication to the LAN 1652, which may also include a wireless access point disposed thereon for communicating with the wireless adaptor 1656.

When used in a WAN networking environment, the computer 1602 can include a modem 1658, or is connected to a communications server on the WAN 1654, or has other means for establishing communications over the WAN 1654, such as by way of the Internet. The modem 1658, which can be internal or external and a wire and/or wireless device, is connected to the system bus 1608 via the serial port interface 1642. In a networked environment, program modules depicted relative to the computer 1602, or portions thereof, can be stored in the remote memory/storage device 1650. It will be appreciated that the network connections shown are exemplary and other means of establishing a communications link between the computers can be used.

The computer 1602 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, for example, computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3 or Ethernet).

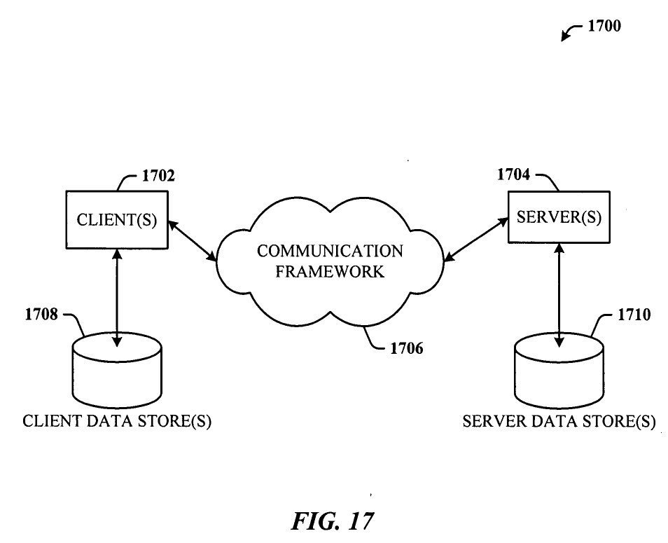

Referring now to FIG. 17, there is illustrated a schematic block diagram of an exemplary computing environment 1700 that facilitates offline tracking and rate information processing in accordance with the disclosed architecture. The system 1700 includes one or more client(s) 1702. The client(s) 1702 can be hardware and/or software (e.g., threads, processes, computing devices). The client(s) 1702 can house cookie(s) and/or associated contextual information, for example.

The system 1700 also includes one or more server(s) 1704. The server(s) 1704 can also be hardware and/or software (e.g., threads, processes, computing devices). The servers 1704 can house threads to perform transformations by employing the architecture, for example. One possible communication between a client 1702 and a server 1704 can be in the form of a data packet adapted to be transmitted between two or more computer processes. The data packet may include a cookie and/or associated contextual information, for example. The system 1700 includes a communication framework 1706 (e.g., a global communication network such as the Internet) that can be employed to facilitate communications between the client(s) 1702 and the server(s) 1704.

Communications can be facilitated via a wire (including optical fiber) and/or wireless technology. The client(s) 1702 are operatively connected to one or more client data store(s) 1708 that can be employed to store information local to the client(s) 1702 (e.g., cookie(s) and/or associated contextual information). Similarly, the server(s) 1704 are operatively connected to one or more server data store(s) 1710 that can be employed to store information local to the servers 1704.

The communications framework 1706 can include the Internet and cellular networks, for example. The clients 1702 and servers 1704 can be employed for the online components 306, as well as for aspects of the offline component 304.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented offline content management system, comprising:
a mobile component of a user for capturing unique indicia associated with offline content; and
a tracking component for tracking user interaction with the offline content based in part on association of a unique mobile identifier of the mobile component with the captured indicia.

2. The system of claim 1, wherein the unique indicia is embodied in at least one of a quick response (QR) code, a bar code, radio frequency identification (RFID) code, or audio/video background noise.

3. The system of claim 1, further comprising a plug-in interface via which a publisher subscribes and receives a referral ID, and via which the publisher obtains end user response rate information.

4. The system of claim 1, wherein the indicia is unique to a publisher such that capturing of the indicia facilitates purchase of an article of commerce of a merchant associated with the publisher.

5. The system of claim 1, wherein the unique mobile identifier is a cell phone number.

6. The system of claim 5, further comprising a web identifier stored in association with the cell phone number wherein offline activity data of the user is logged and used for targeting the user with smart advertisements based on the association.

7. The system of claim 5, wherein a marketing event is presented to the user as an enticement to associate the cell phone number with a web identifier, which association facilitates retrieval of a keyword of a message sent based on the marketing event.

8. The system of claim 7, wherein a user response to the marketing event is logged in association with a user profile, and accumulation of a plurality of the user responses is employed to anticipate information the user will desire to perceive.

9. The system of claim 1, further comprising an accounting component for computing rate information for a publisher of the content based on a content identifier.

10. The system of claim 9, wherein the rate information includes at least one of a response rate or a conversion rate, and quality of the rate information determines a charge rate for a publisher associated with the offline content.

11. The system of claim 1, further comprising a centralized ad component for at least one of advertisement data management, advertisement editorial verification, advertisement delivery, reporting, or publisher control.

12. A computer-implemented method of processing offline user activity, comprising:
sensing unique information of offline content published by a publisher;
decoding the unique information to obtain a publisher referral identifier;
computing a response rate for the offline content; and
reporting the response rate to a merchant.

13. The method of claim 12, further comprising computing a conversion rate for the offline content and, communicating the conversion rate and the response rate to a merchant as measures of performance of the publisher.

14. The method of claim 12, further comprising tracking user interaction with the content based in part on association of a unique mobile identifier of a mobile phone with the captured indicia.

15. The method of claim 12, further comprising encoding a publisher referral identifier into the unique information of the offline content.

16. The method of claim 12, further comprising sensing the unique information using a cell phone, the unique information embedded in a QR code, a bar code, an RFID circuit, or in audio/video background noise.

17. The method of claim 12, further comprising generating a performance report of the publisher based on at least one of the conversion rate or response rate and providing the report to the merchant.

18. The method of claim 12, further comprising extracting keyword data from a message sent in association with sensing the unique information, and storing the keyword data in association with a web identifier and user information.

19. The method of claim 18, further comprising storing the keyword data in a user profile, and processing the user profile for integration in a product by a product integration component.

20. A computer-implemented system, comprising:
computer-implemented means for sensing unique information of offline content;
computer-implemented means for decoding the unique information to obtain referral identifier;
computer-implemented means for computing a conversion rate for the offline content; and
computer-implemented means for reporting the conversion rate to a merchant to assess performance of a publisher of the offline content.
